(19) United States
(12) Patent Application Publication
(10) Pub. No.: US 2021/0016721 A1
(43) Pub. Date: Jan. 21, 2021

(54) ELECTRONIC DEVICE HOLDER FOR THE CAR ROOM MIRROR

(71) Applicant: NEWVIT CO., LTD., Seoul (KR)

(72) Inventor: Ki Sup SHIN, Seoul (KR)

(73) Assignee: NEWVIT CO., LTD.

(21) Appl. No.: 16/669,900

(22) Filed: Oct. 31, 2019

(30) Foreign Application Priority Data
Jul. 17, 2019 (KR) 10-2019-0086374

(51) Int. Cl. B60R 11/02

(52) U.S. Cl. CPC B60R 11/0241; B60R 2011/0033

(57) ABSTRACT

The present disclosure relates to an electronic device holder for a car room mirror, the electronic device holder including: a fixing assembly fixed to a room mirror support provided in a vehicle; a holder body coupled to a lower portion of the fixing assembly to rotate forward, backward, left, and right; and a holding unit formed at a side of the holder body and having a seat on a side on which an electronic device such as a smartphone is seated.

### CROSS REFERENCE TO RELATED APPLICATION

The present application claims priority to Korean Patent Application No. 10-2019-0086374, filed Jul. 17, 2019, the entire contents of which is incorporated herein for all purposes by this reference.

### BACKGROUND OF THE INVENTION

### Field of the Invention

The present disclosure relates to an electronic device holder for a car room mirror, the electronic device holder being fixed to an automotive room mirror support, having a holder body that can rotated left, right, up, and down, having a length adjuster that is stretched in multiple steps for a user to be able to use the holder with a desired length, being easily attached and detached by having a magnetic seat for fixing an electronic device, etc. on the holder.

### Description of the Related Art

Unless stated otherwise in this specification, the contents described in this section are not the related art about the claims of this application and not all of the contents included in this section are regarded as the related art.

In general, various electronic devices such as a controller for ventilation system including a cooling/heating system, a cassette player, a cigar jack, and an ashtray are mounted in the instrument panel (dash panel) of the front side in vehicles to provide convenience for a driver or passengers. Further, recently, holders in which beverage products or cups can be held are increasingly mounted.

Meanwhile, many drivers want to mount a compact disc player having high sound quality, a television, a global positioning system, a PDA, a mobile phone that is a mobile wireless phone, a navigation satellite system, etc., and many holders have been developed to hold these devices on the instrument panel in order to conveniently use them while driving.

Examples of such a holder or cradle have been disclosed in Korean Utility Model No. 20-0161223, etc.

The disclosed cradle or holder has a structure that is fixed to the instrument panel or the windshield of a vehicle using a double-sided tape glass absorption type device or screws or that is fixed to the bottom of a vehicle using a support of the holder and bolts, etc.

Such a holder has a problem that it leaves a scar on the instrument panel or the car body even though it is mounted one time and has a basic problem that when the holder is attached to the windshield of a vehicle, it blocks the visual field of a driver, thereby interfering with safe driving.

Further, as another example, an automotive mobile phone holder has been disclosed in Korean Utility Model No. 20-0203677.

According to the disclosed contents, a circular absorption portion 12 made of a soft synthetic material, a stretchable support 20, and a holder body 40 having a side narrow portion 48 having elasticity and a lower narrow portion 50 are coupled to a connection bracket 16 and first, second, and third angle adjusting portions 13, 14, and 15, thereby forming a holder 10. The holder 20 has a longitudinal insertion space and is composed of a fixing support 26 having an oblong hole 22 at the upper portion and a protrusion 24 at the center portion therein, and a variable support 32 having several locking groves 28 formed longitudinally with regular intervals from the lower portion and having a locking step 30 at the lower end. The holder body 40 has a lateral groove 42 and a longitudinal groove 44 such that an L-shaped side narrow portion 48 and the lower narrow portion 50 elastically supporting a spring 46 are partially seated and coupled in a slide type. Guide grooves 52 are formed at insertion portions of the side narrow portion 48 and the lower narrow portion 50, so a double-enveloping type gear unit 62 composed of a driving gear 54 and a stop gear 56 and having first and second stoppers 58 and 60 is inserted therein. The first, second, and third angle adjusting portions 13, 14, and 15 include a rotary shaft 69 that has a rotary toothed portion 64 at an end and on which a spring 66 is fitted. A rotational protrusion 70 having cap shape is fitted on the other end of the rotary shaft 68 to be integrated by bolting.

This invention has an advantage that since there are a length adjusting portion and angle adjusting portions, so a user can turn and use the holder in desired directions, but since there is an absorption portion that is attached to glass of a vehicle, there is a problem that the absorption ability is deteriorated due to a temperature change in a vehicles.

When temperature drops under zero, for example, in winter and the heater in a vehicle is operated, this automotive holder attached to the windshield of the vehicle drops due to a rapid interior temperature change, so electronic device such as a navigation device is broken.

Further, there is a problem that when an accident such as a collision occurs while a vehicle is driven, passengers may be hurt by electronic devices such as a navigation device attached to the windshield.

Accordingly, there is a need for an automotive holder that can fix an electronic device such as a navigation device at a position that does not hurt passengers, and can be adjusted to be suitable for the angle of a visual field.

### Documents of Related Art

(Patent Document 1) Korean Utility Model No. 20-0161223

(Patent Document 2) Korean Utility Model No. 20-0203677

### SUMMARY OF THE INVENTION

In order to solve the problems, an objective of the present invention is to provide an electronic device holder for a car room mirror, the holder having a fixing assembly that is fixed to a room mirror support in a vehicle, keeping a fixing force even under a temperature change by using a cable tie type rather than an air absorption type, having a large fixing force by locking teeth of a fixing member to threads of a female thread unit, and being economical by reducing the manufacturing cost.

The present disclosure relates to an electronic device holder for a car room mirror, the electronic device holder including: a fixing assembly fixed to a room mirror support provided in a vehicle; a holder body coupled to a lower portion of the fixing assembly to rotate forward, backward, left, and right; and a holding unit formed at a side of the holder body and having a seat on a side on which an electronic device such as a smartphone is seated.

According to a characteristic of the present disclosure, the fixing assembly may include; a fixing assembly body having a male thread portion at a lower portion and having a fitting hole at a first side; and a fixing member having a toothed portion extending from a second side of the fixing assembly body and having several coupling protrusions on a side, in which a toothed portion may be coupled to a female thread portion having a thread on an inner side thereof through the fitting groove.

According to a characteristic of the present disclosure, a length adjuster that stretches and contracts in several steps may be disposed in the holder body.

According to a characteristic of the present disclosure, a ball type rotor to which the holding unit may be rotatably coupled is disposed at an end of the holder body.

According to a characteristic of the present disclosure, holder body protrusions having a through-hole on an side and protruding upward may be formed on a to of the holder body; a connection hole may be formed through a lower portion and connection holes recessed inward such the holder body protrusions are inserted may be formed on a side of the connection hole, and a connector protruding upward and having a rotational protrusion that is inserted in the female thread unit may be further formed at an upper portion.

According to a characteristic of the present disclosure, fixing grooves recessed inward at both sides may be formed on a top of the fixing assembly.

According to a characteristic of the present disclosure, fixing pads made of a silicon material are formed on a top of the fixing assembly.

According to the present disclosure, the electronic device holder for a car room mirror can hold an electronic device at a position that a user wants and the toothed portion of the coupling member is coupled and fixed to the thread of the female thread unit, so there is no need for specific stopper. Therefore, the manufacturing cost is reduced, which is economically advantageous.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view showing the state of use according to an embodiment of the present disclosure;

FIG. 2 is a perspective view showing main parts according to an embodiment of the present disclosure;

FIG. 3 is an exploded perspective view according to an embodiment of the present disclosure;

FIG. 4 is a perspective view showing rotation for use according to an embodiment of the present disclosure; and

FIG. 5 is a perspective view showing rotation for use according to an embodiment of the present disclosure.

### DETAILED DESCRIPTION OF THE INVENTION

The advantages and features of the present invention, and methods of achieving them will be clear by referring to the embodiments that will be describe hereafter in detail with reference to the accompanying drawings. However, the present invention is not limited to the exemplary embodiments described hereafter and may be implemented in various ways, and the exemplary embodiments are provided to complete the description of the present invention and let those skilled in the art completely know the scope of the present invention and the present invention is defined by claims. Like reference numerals indicate like components throughout the specification.

In the following description of embodiments of the present invention, detailed descriptions of well-known functions or configurations relating to the present invention will not be provided so as not to obscure the description of the present invention with unnecessary details. Further, the following terminologies are defined in consideration of the functions in the present disclosure and may be construed in different ways by the intention or practice of users and operators. Therefore, the definitions thereof should be construed based on the contents throughout the specification.

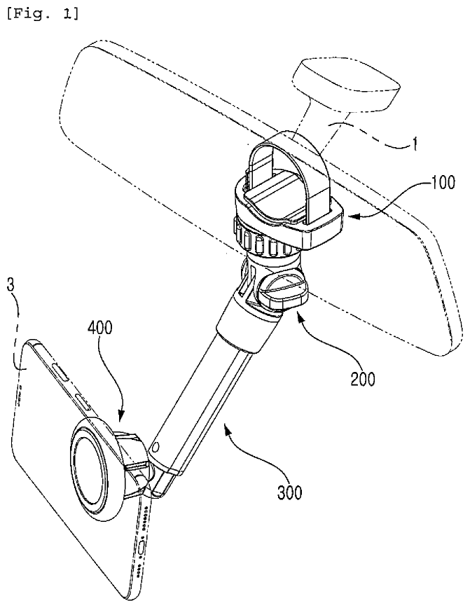

The present disclosure, as shown in FIG. 1, relates to an electronic device holder for a car room mirror that supports an electronic device 3 such as a smartphone by being coupled to a room mirror support 1 or a gear rod installed in a vehicle.

As shown in FIG. 1, a side of a room mirror support 1 is seated on the top of a fixing assembly 100.

The fixing potion 100 may be formed in various shapes depending on the shape of the room mirror support 1.

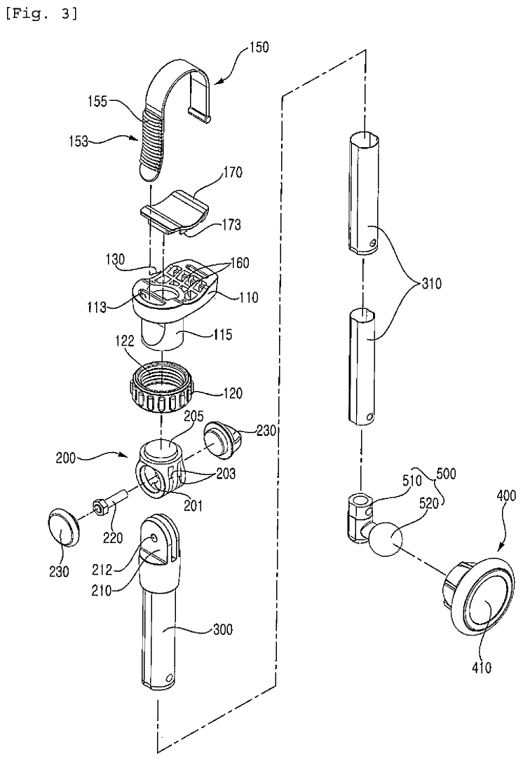

However, since the automotive room mirror supports 1 are usually formed in a cylindrical shape or a bar shape, as shown in FIG. 3, a fixing groove 130 in which the room mirror support 1 is inserted and fixed may be formed.

As shown in FIG. 3, the room mirror support 1 should be stably fixed in the fixing groove 130, the fixing groove 130 may be formed inward at both sides on the top of the fixing assembly 100.

Accordingly, when the room mirror support 1 is inserted in the fixing grooves 130, the room mirror support 1 can be firmly coupled to the fixing assembly 100.

Further, as shown in FIG. 3, a fixing pad 170 made of a rubber or silicon material may be disposed in the fixing grooves 130.

The fixing pad 170 may be fixed in the fixing grooves 130 in various ways such as thread-fastening and bonding.

However, as shown in FIG. 3, several fitting grooves 160 may be formed on the top of the fixing assembly 100 to reduce the manufacturing cost using extrusion or injection, and fitting protrusions 173 having a shape corresponding to the fitting grooves 160 may be formed on the bottom of the fixing pad 170.

By this structure, a user can easily attach/detach, the fixing pad 170 and the automotive room mirror support 1 can be fixed to the fixing assembly 100 without slipping.

As shown in FIG. 3, the fixing assembly 100 is composed of a fixing assembly body 110 and a fixing member 150.

A male thread portion 115 protrudes downward from the bottom of the fixing assembly body 110.

A thread 122 corresponding to a thread 122 of a female thread unit 120 is formed on the outer side of the male thread portion 115, so, in locking, the threads 122 are engaged, whereby the female thread unit 120 can be fixed to the male thread portion 115.

As another embodiment, the thread 122 may not be formed on the outer side of the male thread portion 115.

In this case, although the thread 122 is not formed, that is, there is no configuration to which the thread 122 of the female thread unit 120 can be coupled, when the female thread unit 120 is a nut to be described below, the protruding portion of the male thread portion 115 can function as a guide for the female thread unit 120.

The shape or the kind of the male thread portion 115 is well known in the art, so it is not described in detail.

As shown in FIG. 3, a fitting hole 113 is formed through a side of the fixing assembly body 110.

The shape, the length of the long axis, the depth, etc. of the fitting hole 113 may be changed in various ways, but the fixing member 150 to be described above is supposed to be coupled to the female thread unit 120 through the fitting hole 113, so the shape of the fitting hole 113 and the length of the long axis may be set in various ways to correspond to the shape of the fixing member 150.

Various fixing methods such as a Velcro type, a cable tie type, etc. may be used for the fixing member 150.

However, according to the Velcro type, there is a problem that it is required to further disposing a bonding member on the top of the fixing assembly body 110 and the adhesive fixing force depending on the lifespan decreases. Accordingly, the cable tie type having high coupling-fixing force and durability may be used.

To this end, as shown in FIG. 3, the fixing member 150 may be manufacture in a belt or band shape extending from a second side of the fixing assembly body 110.

Further, as shown in FIG. 3, a toothed portion 153 having several coupling protrusions 155 may be formed on a side of an end portion of the fixing member 150.

The toothed portion 153 is coupled through the fitting hole 113 of the fixing assembly body 110 by a so-called cable tie type. In order that the coupling protrusions 155 of the toothed portion 153 are coupled to the fitting hole 113 by the cable tie type, the toothed portion 153 should be formed on the inner side or the outer side of the fixing member 150 and several stoppers should be formed on a side of the fitting hole 113 at positions corresponding to the positions of the toothed portion 153.

Such a cable tie type of coupling structure and the shape of the components are well known in the art, so they are not described in detail.

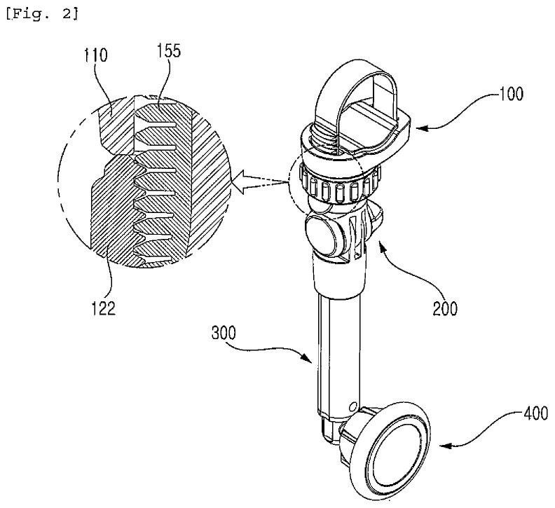

However, according to the present disclosure, the toothed portion 153 is not coupled and fixed to specific stoppers, but, as shown in FIG. 2, the toothed portion 153 is coupled and fixed to the thread 122 formed on the inner side of the female thread unit 120.

The thread 122 of the female thread unit 120 functions as a stopper.

To this end, as shown in FIG. 3, the toothed portion 153 should be formed in the outer side of an end portion of the fixing member 150.

Accordingly, when a user puts the toothed portion 153 of the fixing member 150 into the fitting hole 113 and locks the female thread unit 120 to the male thread portion 115, the coupling protrusions 155 of the toothed portion 153 are coupled to the thread 122 of the female thread unit 120, whereby the user can fix the electronic device holder for a car room mirror to the automotive room mirror support 1 without a specific stopper.

It is possible to fix the electronic device holder for a car room mirror without a specific stopper using this fixing method, and accordingly, the manufacturing cost can be reduced, so a user is provided with an economic advantage.

The kind and size of the female thread unit 120 may be changed in various ways; however, considering the shape of the male thread portion 115 protruding downward, a hollow nut-shaped female thread unit 120 may be used.

Accordingly, the coupling protrusions 155 of the toothed portion 153 protrude out of the fixing assembly body 110 through the fitting hole 113 and the thread 122 of the female thread unit 120 is coupled to the coupling protrusions 155 protruding outward, thereby pressing the automotive room mirror support 1 seated on the fixing assembly 100.

The kind, shape, coupling method, etc. of the female thread unit 120 and the male thread portion 115 are well known in the art, so they are not described in detail.

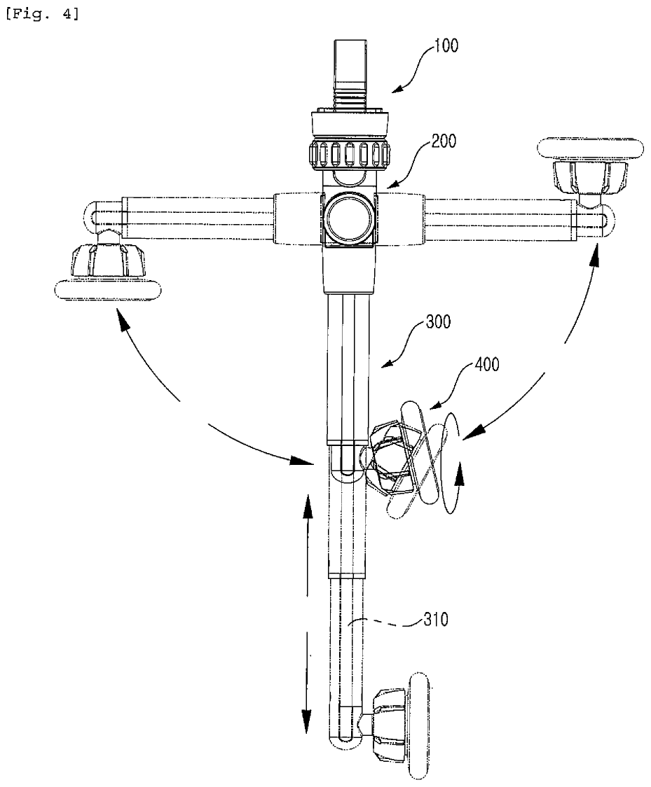

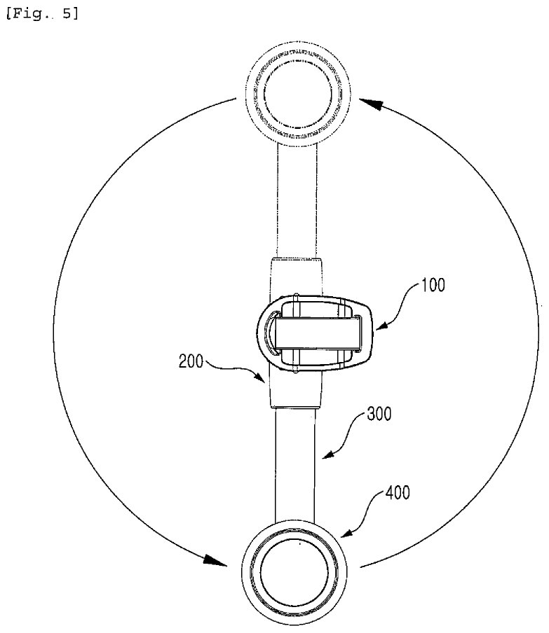

As shown in FIGS. 4 and 5, a holder body 300 is rotatably coupled to the, lower portion of the fixing assembly 100.

Various rotary components may be used for the rotatable coupling method.

For example, as shown in FIG. 3, a connector 200 having a connection hole 201 formed through the lower portion thereof and having a rotational protrusion 205 inserted in a through-hole 212 formed through the center of the female thread unit 120 (nut shape) may be provided.

The rotational protrusion 205 may be formed in various shapes such as a circle and a rectangle, but the outer circumferential surface of the rotational protrusion 205 may form an arc shape, as shown in FIG. 3, because the shape of the nut type female thread portion 120 is generally a circular shape and in order to rotate the holder body 300 360 degrees, as shown in FIG. 5.

Further, in order to rotate the holder body 300 360 degrees, a groove may be formed on the bottom (not shown) of the male thread portion 115 and the rotational protrusion 205 may have a circular shape with a diameter that can be fitted in the groove.

As shown in FIG. 3, a plurality of connection grooves 203 recessed inward and having a shape corresponding to the connection hole 201 may be formed at the lower portion of the connector 200.

The connection grooves 203 are formed to couple the connector 200 to the upper portion of the holder assembly 300 and holder body protrusions 210 having a through-hole 212 on a side are formed on the top of the holder body 300.

As shown in FIG. 3, the holder body protrusions 210 are inserted in the connection grooves 203 and a fixing bar 220 is inserted through the connection hole 201 and the through-holes 212 of the holder assembly protrusions 210, whereby the fixing assembly 100 is coupled to the lower portion of the holder body 300.

Further, as shown in FIGS. 3 and 4, the as the holder body protrusions 210, the connection grooves 203, and the fixing bar 220 are coupled, the holder body 300 can rotate forward and backward maximally 90 degrees.

Further, as shown in FIG. 3, a cap 230 fitted on the outer surface around the connection hole 201 is further provided, so it is possible to increase the fixing force between the holder body 300 and the fixing assembly 100 and to smoothly finish the external appearance.

The shape and kind of the cap 230 are well known in the art, so they are not described in detail.

As shown in FIG. 3, the holder body 300 has a space therein and has a predetermined length.

The holder body 300 may have various shapes such as a rectangular parallelepiped and a cube, but a length adjuster 310 composed of several booms that can stretch and contract in several steps is supposed to be inserted in the holder body 300 and these booms are generally formed in a cylindrical pipe shape, so the holder body 300 may also be formed in a cylindrical shape.

The length adjuster 310 is applied to a selfie stick, a fishing rod, etc., and well known in the art, so it is not described in detail.

As shown in FIGS. 1 to 5, a holding unit 400 to which an electronic device such as a smartphone is attached is formed at an end of the holder body 300.

The holding unit 400 may be formed in various shapes such as a rectangle and a circle.

However, an electronic device is held with a side in contact with a seat 410 formed on a side of the holding unit 400, so, as show in FIG. 3, a flat seat 410 may be formed at the portion to which an electronic device is attached.

The seat 410 may be made of a magnetic material in consideration of the magnetic property of electronic devices.

However, in order to more stably attach an electronic device to the seat 410 using magnetism, an attachment plate (not shown) made of a material (steel) that is attached to a magnet may be coupled to the rear of the electronic device.

The attachment plate is well known in the art, so it is not described in detail.

By this magnetism, a user can easily attach and detach, an electronic device, etc. to and from the holder.

As shown in FIG. 3, a ball type rotor 500 may be disposed at an end of the holder body 300.

The ball type rotor 500 is composed of a ball body 510 inserted in the holder body 300 and a ball head 520 bending a predetermined angle from an end of the rotor body.

The ball body 510 may be formed in various shapes, but, as described above, it is supposed to be inserted into the cylindrical holder body 300, so it may be formed in a cylindrical shape and may have a diameter to be forcibly fitted into the holder body 300.

The bending angle may also be various, but the objective of the present disclosure is to enable a user to conveniently use an electronic device such as a smartphone, so the bending angle may be a right angle forward (toward the user's eyes) from the holder body 300.

The rear side of the holding unit 400 is rotatably coupled to the ball head 520, and the shape and the rotatable coupling method of the ball head 520 are well known in the art, so they are not described in detail.

Although embodiments of the present disclosure were described above with reference to the accompanying drawings, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application. Therefore, it should be understood that the embodiment described above is not limitative, but only an example in all respects, the scope of the present invention is expressed by claims described below, not the detailed description, and it should be construed that all of changes and modifications achieved from the meanings and scope of claims and equivalent concept are included in the scope of the present invention.

What is claimed is:

1. An electronic device holder for a car room mirror, the electronic device holder comprising:
a fixing assembly fixed to a room mirror support provided in a vehicle;
a holder body coupled to a lower portion of the fixing assembly to rotate forward, backward, left, and right; and
a holding unit formed at a side of the holder body and having a seat on a side on which an electronic device such as a smartphone is seated.

2. The electronic device holder of claim 1, wherein the fixing assembly includes;
a fixing assembly body having a male thread portion at a lower portion and having a fitting hole at a first side; and
a fixing member having a toothed portion extending from a second side of the fixing assembly body and having several coupling protrusions on a side,
wherein a toothed portion is coupled to a female thread portion having a thread on an inner side thereof through the fitting groove.

3. The electronic device holder of claim 1, wherein a length adjuster that stretches and contracts in several steps is disposed in the holder body.

4. The electronic device holder of claim 1, wherein a ball type rotor to which the holding unit is rotatably coupled is disposed at an end of the holder body.

5. The electronic device holder of claim 2, wherein holder body protrusions having a through-hole on an side and protruding upward are formed on a to of the holder body,
a connection hole is formed through a lower portion and connection holes recessed inward such the holder body protrusions are inserted are formed on a side of the connection hole, and
a connector protruding upward and having a rotational protrusion that is inserted in the female thread unit is further formed at an upper portion.

6. The electronic device holder of claim 1, wherein fixing grooves recessed inward at both sides are formed on a top of the fixing assembly.

7. The electronic device holder of claim 1, wherein fixing pads made of a silicon material are formed on a top of the fixing assembly.
